(19) United States
(12) Patent Application Publication
(10) Pub. No.: US 2017/0143581 A1
(43) Pub. Date: May 25, 2017

(54) MASSAGE STICK

(71) Applicant: Kuan Chih Wang, Tainan (TW)

(72) Inventor: Kuan Chih Wang, Tainan (TW)

(21) Appl. No.: 14/949,901

(22) Filed: Nov. 24, 2015

(51) Int. Cl. A61H 15/00

(52) U.S. Cl. CPC A61H 15/0092; A61H 2015/0014

(57) ABSTRACT

A massage stick includes a rod, a masssage tube, two tube stoppers, two handles and two heads. The rod extends through the massage tube and each tube stopper is secured on the rod. Each tube stopper has a first shoulder in the hole thereof. The two handles are mounted to the two sides of the rod and each has a second passage in which second shoulders and a contact face are formed. The two heads are respectively connected to the two handles, and each has a shank and a massage end. The user holds the handles to massage the body by rolling the massage tube. Alternatively, the user holds the massage tube to massage the body by rolling the handles. The user may hold the handles or the massage tube to massage the body by pressing the massage ends onto the body.

### BACKGROUND OF THE INVENTION

1. Fields of the Invention

The present invention relates to a massage stick, and more particularly, to a massage stick having a massage tube with two handles on two ends thereof, each handle having uneven massage portion for body massage.

2. Descriptions of Related Art

The conventional massage stick comprises a shaft with multiple rollers on the middle portion thereof, each roller has protrusions formed on the outside thereof. The user holds the two ends of the shaft and rolls the rollers back and forth on a specific body part to make the protrusions massage the specific body part. However, there is no massage function on each end of the shaft of the conventional massage stick, resulting in some body parts unable to be massaged by rolling the roller.

The present invention intends to provide a massage stick to eliminate the shortcomings mentioned above.

### SUMMARY OF THE INVENTION

The present invention relates to a massage stick and comprises a rod which extends through a first passage in a massage tube. Two tube stoppers are secured on the rod respectively, and each tube stopper has a hole and a first shoulder are formed in the inner periphery of the hole. Two handles, each having a first end and a second end, are mounted to the two sides of the rod respectively. The first end of each handle is connected to the tube stopper corresponding thereto. Each handle has a second passage defined axially therethrough. A second shoulder is defined in the inner periphery of each of the first and second end of the passage of each handle. A contact face is formed in the inner periphery of the second end of each handle and located between the second passage and the end face of the second end of each handle. Two heads each has a shank and a massage end, wherein the shank is force-fitted into the second end of the handle and engaged with the contact face corresponding thereto.

Preferably, the rod has threads formed on each of two ends thereof. Two first bearings, two sleeves, two first washers, two second bearings, two second washers and two nuts are respectively located in each of the two handles. The sleeves are respectively mounted to the rod and located between the first and second ends of the handles. The first bearings are mounted to the rod respectively and are abutted to the second shoulders in the first end of the handles. The first washers are respectively mounted to the rod and engaged with the second shoulder in the second end of the handle. The second bearings are respectively mounted to the rod and located between the first washers and the second washers which are mounted to the rod respectively. The nuts are threadedly connected to the threads of the rod respectively and are abutted to the second washers.

Preferably, each of the handles has a massage portion formed on the outside thereof.

The primary object of the present invention is to provide a massage stick which not only has massage tube in the middle of the massage stick but also has a massage portion on the handles so as to massage different body parts.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the massage stick of the present invention;

FIG. 2 is a cross sectional view to show the connection of the handle, the head and the rod on each end of the massage stick of the present invention;

FIG. 3 is a perspective view to show the massage stick of the present invention, and

FIG. 4 is a cross sectional view to show the operation of the massage stick of the present invention.

### DETAILED DESCRIPTION OF THE PREFERRED EMBODIMENT

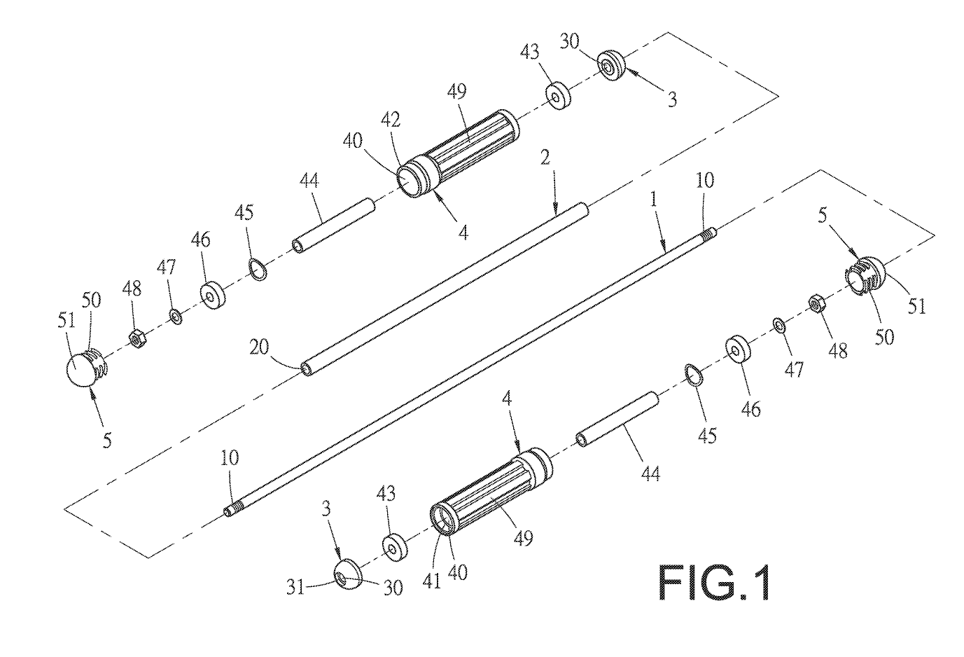

Referring to FIGS. 1, the massage stick of the present invention comprises a rod 1, a massage tube 2, two tube stoppers 3, two handles 4 and two heads 5. The rod 1 has threads 10 formed on each of two ends thereof. The massage tube 2 has a first passage 20 defined axially therethrough and the rod 1 extends through the first passage 20 of the massage tube 2.

The two tube stoppers 3 are secured on the rod 1 respectively. Each tube stopper 3 has a hole 30, and a first shoulder 31 are formed in the inner periphery of the hole 30. The two handles 4, made of rubber or plastics to reduce the manufacturing cost, are mounted to the two sides of the rod 1 respectively, and each handle 4 has a first end and a second end. The first end of each handle 4 is connected to the tube stopper 3 corresponding thereto. Each handle 4 has a second passage 40 defined axially therethrough, and a second shoulder 41 is defined in the inner periphery of each of the first and second end of the passage 40 of each handle 4. A contact face 42 is formed in the inner periphery of the second end of each handle 4 and located between the second passage 41 and the end face of the second end of each handle 4. Each handle 4 has a massage portion 49 formed on the outside thereof. Two first bearings 43, two sleeves 44, two first washers 45, two second bearings 46, two second washers 47 and two nuts 48 are respectively located in each of the two handles 4. Two heads 5 each has a shank 50 and a massage end 51. The heads 5 are made of rubber or plastics to reduce the manufacturing cost. The shanks 50 are force-fitted into the second end of the handles 4 and engaged with the contact face 42 corresponding thereto.

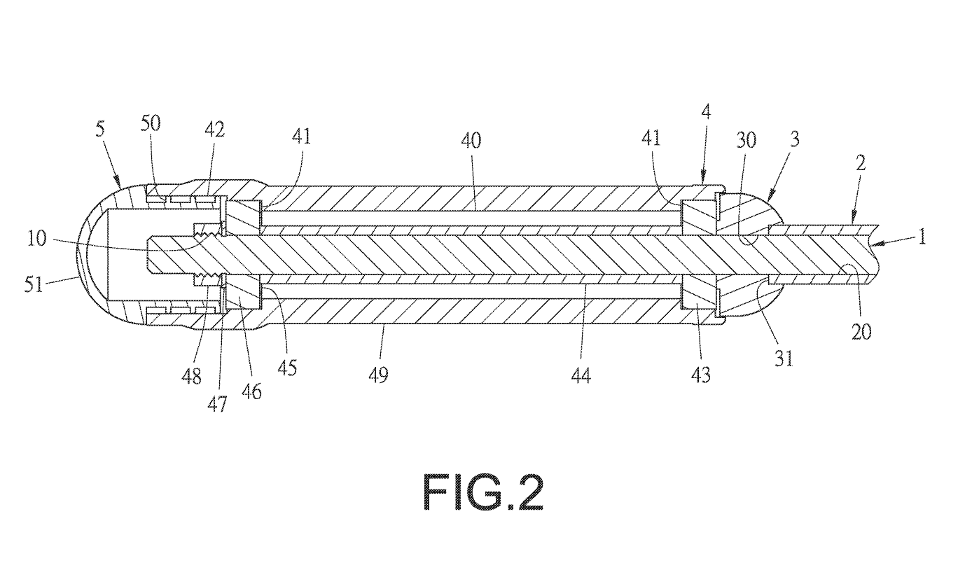

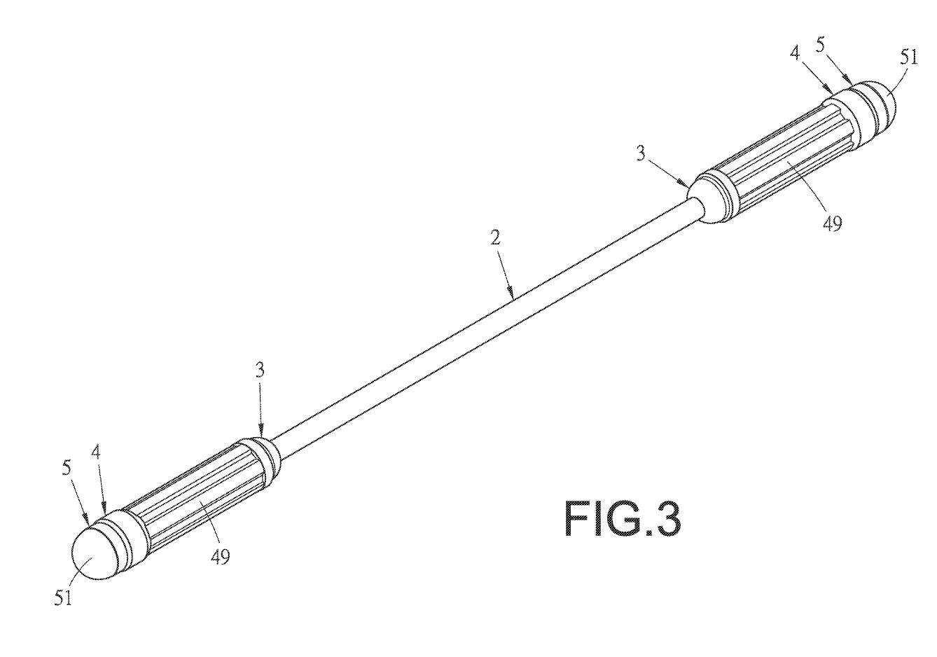

As shown in FIGS. 1 to 3, when assembling the massage stick, the rod 1 extends through the first passage 20 of the massage tube 2. Two tube stoppers 3 are secured on the rod 1 respectively through the hole 30 of each tube stopper 3. The first shoulders 31 of tube stoppers 3 are abutted to two ends of the massage tube 2. The first bearings 43 are mounted to the rod 1 respectively and are abutted to the tube stoppers 3. Two handles 4 are mounted to the rod 1 respectively and each first bearing 43 is biased between the tube stopper 3 and the second shoulder 41 in the first end of the handle 4. The sleeves 44 are respectively mounted to the rod 1 and located between the first and second ends of the handles 4. The first washers 45 are respectively mounted to the rod 1 and engaged with the second shoulders 41 in the second end of the handles 4. The second bearings 46 are respectively mounted to the rod 1 and located between the first washers 45 and the second washers 47 which are mounted to the rod 1 respectively. The nuts 48 are threadedly connected to the threads 10 of the rod 1 respectively and are abutted to the second washers 47. The heads 5 are then connected to the second end of the handles 4 respectively, and the shanks 50 are force-fitted into the second end of the handles 4 and engaged with the contact face 42 corresponding thereto.

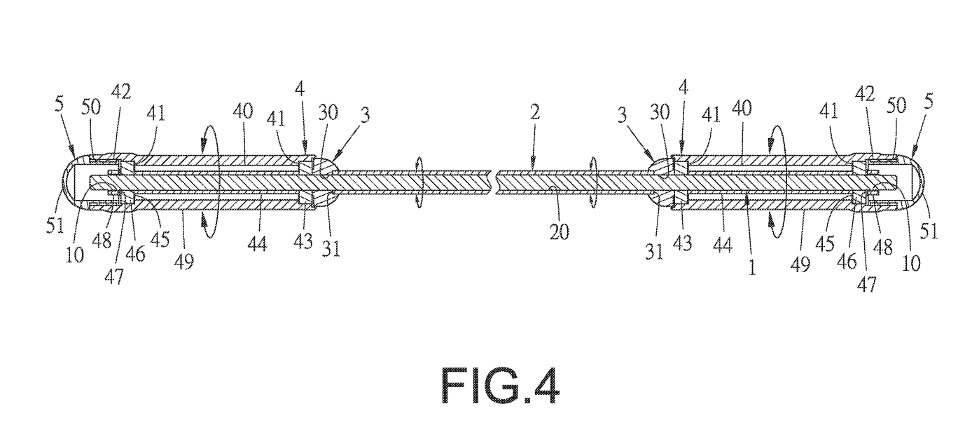

When in use, as shown in FIG. 4, the user holds the massage portions 49 of the two handles 4, and rolls the massage tube 2 back and forth to massage the body. Alternatively, the user may hold the massage tube 2 and rolls the handles 4, using the massage portions 49 to massage the body. Alternatively, the user may hold the massage tube 2 or the massage portions 49 of the handles 4 to massage the body by pressing the massage ends 51 of the heads 5 onto the body. Therefore, the massage stick of the present invention provides various ways to massage every body parts and is easy to use.

While we have shown and described the embodiment in accordance with the present invention, it should be clear to those skilled in the art that further embodiments may be made without departing from the scope of the present invention.

What is claimed is:

1. A massage stick comprising:
a rod;
a massage tube having a first passage defined axially therethrough and the rod extending through the first passage of the massage tube;
two tube stoppers secured on the rod respectively, each tube stopper having a hole, a first shoulder formed in an inner periphery of the hole;
two handles each having a first end and a second end, the first end of each handle connected to the tube stopper corresponding thereto, each handle having a second passage defined axially therethrough, a second shoulder defined in an inner periphery of each of the first and second end of the passage of each handle, a contact face formed in an inner periphery of the second end of each handle and located between the second passage and an end face of the second end of each handle, and
two heads each having a shank and a massage end, the shank force-fitted into the second end of the handle and engaged with the contact face corresponding thereto.

2. The massage stick as claimed in claim 1, wherein the rod has threads formed on each of two ends thereof, two first bearings, two sleeves, two first washers, two second bearings, two second washers and two nuts are respectively located in each of the two handles, the first bearings are mounted to the rod respectively and abutted to the second shoulders in the first end of the handles, the sleeves are mounted to the rod respectively and located between the first and second ends of the handles, the first washers are respectively mounted to the rod and engaged with the second shoulder in the second end of the handles, the second bearings are respectively mounted to the rod and located between the first washers and the second washers which are mounted to the rod respectively, the nuts are threadedly connected to the threads of the rod respectively and abutted to the second washers.

3. The massage stick as claimed in claim 1, wherein each handle has a massage portion formed on an outside thereof.
